(19) United States
(12) Patent Application Publication
(10) Pub. No.: US 2025/0130536 A1
(43) Pub. Date: Apr. 24, 2025

(54) Automated Electrical Component Identification for HVAC Systems

(71) Applicant: Rheem Manufacturing Company, Atlanta, GA (US)

(72) Inventors: Michael John Knieser, Fishers, IN (US); Harold Gene Havard, JR., Fort Smith, AR (US)

(21) Appl. No.: 18/925,466

(22) Filed: Oct. 24, 2024

Related U.S. Application Data
(60) Provisional application No. 63/592,782, filed on Oct. 24, 2023.

(51) Int. Cl. G05B 13/02

(52) U.S. Cl. CPC G05B 13/024

(57) ABSTRACT

Automated identification of electrical devices coupled to heating, ventilation, and air conditioning (HVAC) systems are disclosed. Embodiments may include a system having an identification unit, and a controller. The identification unit is associated with the electrical device. The identification unit is configured to generate an identification information representing at least one electrical parameter of the associated electrical device. The controller is electrically coupled to the electrical device. The controller is configured to determine a device type of the electrical device based on processing the identification information from the identification unit. The controller is configured to determine an operating parameter for the electrical device based, at least in part, on the determined device type.

### CROSS-REFERENCE TO RELATED APPLICATIONS

This application claims priority to and benefit of U.S. provisional patent application No. 63/592,782 filed Oct. 24, 2023, which is herein incorporated by reference.

### FIELD

This disclosure relates generally to electrical devices, and more particularly to automated identification of electrical devices coupled to heating, ventilation, and air conditioning (HVAC) systems.

### BACKGROUND

For monitoring and optimizing usage of the electrical devices, several control systems are used. Electrical devices may have distinct functional characteristics. For example, an electrical device might be set to run at certain parameters, whereas another electrical device may run at different parameters. New electrical devices with more efficient parameters are being introduced daily. Therefore, when any faulty electrical device is replaced with a new electrical device, it may be run at the parameters of the old equipment, which could be suboptimal for the new electrical device.

Electrical device manufacturers employ different production technologies. Although the size of the produced electrical device is consistent with a standard (for example, having a standard interface and a standard size), internal electrical parameters of the device may be different. For example, internal parameters may be rotor magnetic linkage, d-axis inductance, structure-borne noise, speed, torque, and quadrature axis inductance, and are generally varied by the suppliers as per user requirements. When a control system uses electrical devices from different manufacturers, the electric current flowing in the control system gets affected due to internal parameters of each electrical device from different manufacturers. Therefore, it is necessary for the control system to know the internal parameters of each electrical device, particularly when the electrical device is produced by a different manufacturer. Generally, for recording and evaluating the internal parameters, specific sensors are employed within the electrical device. The specific sensors must be adapted to the respective environment. However, this results in increased manufacturing costs and additional installation space.

In light of the above mentioned shortcomings of conventional internal parameters identifying systems, there is a need for a system that is configured to identify a type of electrical device in an effective and simple manner such that a control system associated with the electrical device is aware of the specification of the electrical device and provides a proper controlling and operative environment.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1 illustrates an electrical connection of an electrical device and a control unit.

FIG. 2 is a schematic diagram of a system for identifying an electrical device, according to aspects of the present disclosure.

FIG. 3 is a schematic diagram of a system for identifying a motor, according to aspects of the present disclosure.

FIG. 4 is a flowchart illustrating one exemplary embodiment of a method of identifying an electrical device.

### DETAILED DESCRIPTION

This disclosure relates to automated identification of electrical devices coupled to heating, ventilation, and air conditioning (HVAC) systems. In industrial applications, a control system is employed to control the functionality of the electrical device. For example, an electrical device might be set up to run at specific parameters, whereas another electrical device performs better at different parameters. It is required that the control system and the electrical device are compatible with each other, i.e., the control system is aware of the optimized operating parameters of the electrical device. Currently, a number of sensors are deployed with the electric motor to sense a number of parameters associated with the electrical device. However, the performance of the sensors is highly affected by the environment and the operative conditions of the electrical device.

To address such issues, the present disclosure provides automated identification of electrical devices coupled to heating, ventilation, and air conditioning (HVAC) systems. The system is configured to determine a type of electrical device in an effective and simple manner such that a control system associated with the electrical device is aware of the specification of the electrical device and provides a proper controlling and operative environment.

In some embodiments, the system includes an identification unit, and a controller. The identification unit is associated with the electrical device. The identification unit is configured to generate identification information representing at least one electrical parameter of the associated electrical device. The controller is electrically coupled to the electrical device. The controller is configured to determine a device type of the electrical device based on processing the identification information from the identification unit. The controller is configured to determine an operating parameter for the electrical device based, at least in part, on the device type.

In another embodiment, a method of identifying an electrical device includes electrically coupling an electrical device with a controller; generating an identification information of the electrical device by an identification unit associated with the electrical device; determining a device type of the electrical device, by a controller, based on processing an identification information from the identification unit; and determining an operating parameter for the electrical device, by the controller, based at least in part on the device type.

In yet another embodiment, the system for identifying a motor includes an identification unit, a communication device, and a motor controller. The identification unit is associated with the motor. The communication device is associated with the motor. The communication device is configured to communicate the identification information from the motor. The motor controller is electrically coupled to the motor. The motor controller is configured to determine a type of the motor based on processing the identification information from the identification unit The motor controller is configured to determine an operating parameter for the motor based, at least in part, on the device type.

In another example, a system for identifying electrical devices may include an identification unit associated with a first electrical device and a second electrical device, where the first electrical device is a first motor, and the second electrical device is a second motor, and where the identification unit is configured to generate (i) first identification information representing at least one electrical parameter of the first motor, and (ii) second identification information representing at least one electrical parameter of the second motor. The system may include a first communication device associated with the first motor, the first communication device configured to communicate the first identification information from the first motor, a second communication device associated with the second motor, the second communication device configured to communicate the second identification information from the second motor, and a motor controller, electrically coupled to the first motor and the second motor. The motor controller may be configured to: determine a first device type of the first motor based on processing the first identification information from the first identification unit, determine a first operating parameter for the first motor based, at least in part, on the first device type, determine a second device type of the second motor based on processing the second identification information from the second identification unit, and determine a second operating parameter for the second motor based, at least in part, on the second device type. Any number of electrical devices may be used.

In yet further embodiments, identification of the motor may be performed based on direct measurements from the motor. For example, the resistance across the windings of the motor may be determined by applying a known voltage to the motor and measuring the resulting current. The resistance may then be determined using Ohm's law (V=I*R). The motor may then be identified using the resistance value. This same approach may be used to identify any other type of component as well.

In yet further embodiments, the motor may also be identified by applying sets of pre-stored parameters to the motor and determining if the motor functions in an intended manner based on the application of the particular set of parameters. That is, different sets of parameters associated with different types of motors may be stored in memory (a first set of pre-determined parameters may be associated with a first type of motor, a second set of pre-determined parameters may be associated with a second type of motor, etc.).

As one example of this approach, the parameters that should result in the motor operating a speed of 1000 rotations per minute (RPM) (if the motor is the type of motor associated with the set of parameters) may be applied to the motor. For example, a first set of parameters may be applied to the motor. If the motor then operates at 1000 RPM based on the application of the first set of parameters, it may be determined that the motor is the first type of motor associated with the first set of parameters. However, if the motor does not operate at 1000 RPM, then it may be determined that the motor is not the first type of motor. The second set of parameters may be applied to the motor and this process may iterate until the set of parameters that result in the motor operating at 1000 RPM are identified. The use of the RPM value as the output value that is used to confirm whether the motor matches the applied set of parameters is merely exemplary and any other motor functionality may also be used in place, or in addition to, the RPM value.

Non-limiting examples of parameters are provided below in Table 1.

TABLE 1

| | | | | Number | | |
|---|---|---|---|---|---|---|
| | Address | Offset | Variable | Type | Units | Description |
| First | 0 | 0 | M | 32-bit | Wb | Permanent |
| Com- | | | | float | | Magnetic |
| pressor | | | | | | Flux |
| Slot | | | | | | |
| | 4 | | R | 32-bit | Ohms | Winding |
| | | | | float | | Resistance |
| | 8 | | Ld | 32-bit | H | D-axis |
| | | | | float | | inductance |
| | 12 | | Lq | 32-bit | H | Q-axis |
| | | | | float | | inductance |
| | 16 | | J | 32-bit | kgm\hat{ }2 | Rotor |
| | | | | float | | intertia |
| | 20 | | Nom_I | 32-bit | Arms | Nominal |
| | | | | float | | Current of |
| | | | | | | the motor |
| | | | | | | in Arms |
| | 24 | | Pole_Pairs | 16-bit | | Number of |
| | | | | unsigned | | motor pole |
| | | | | integer | | pairs |
| | 26 | | Id_Ref_ | 32-bit | Amps | Id |
| | | | Low | float | | reference |
| | | | | | | current |
| | | | | | | when in |
| | | | | | | low speed |
| | 30 | | Min_ | 16-bit | RPM | Minimum |
| | | | Speed | unsigned | | reference |
| | | | | integer | | speed |
| | 32 | | Max_ | 16-bit | RPM | Maximum |
| | | | Speed | unsigned | | reference |
| | | | | integer | | speed |
| | 34 | | OverSpeed_ | 16-bit | RPM | Over speed |
| | | | Limit | unsigned | | limit |
| | | | | integer | | |
| | 36 | | Id_Down_ | 16-bit | RPM | Speed to |
| | | | Speed | unsigned | | start |
| | | | | integer | | decreasing |
| | | | | | | Id |
| | 38 | | Id_Up_ | 16-bit | RPM | Speed to |
| | | | Speed | unsigned | | start |
| | | | | integer | | increasing |
| | | | | | | Id |

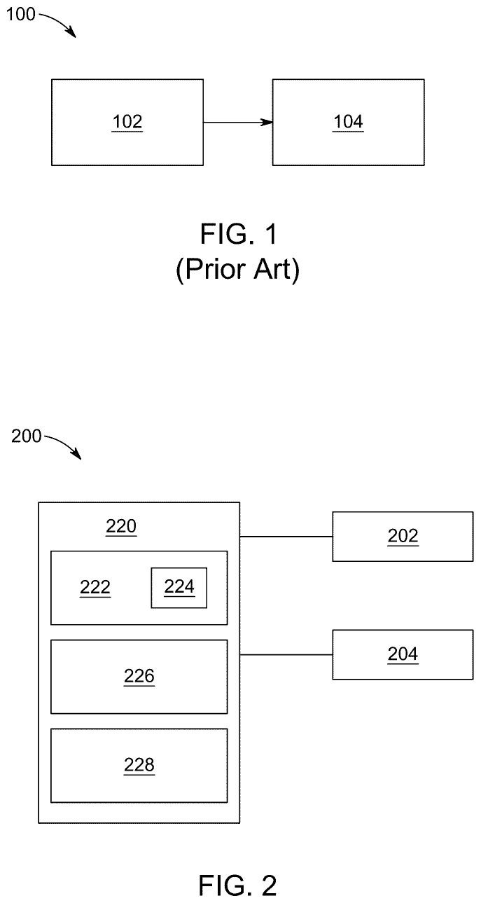

FIG. 1 illustrates a schematic diagram 100 illustrating an electrical connection between a control unit 102 (“control board” or “controller”) and an electrical device 104 according to prior art. In aspects, the control unit 102 may be connected to the electrical device 104 via a drive board.

The control unit 102 is electrically coupled to the electrical device 104. The control unit 102 is configured to operate the electrical device 104. In an embodiment, the control unit 102 is configured to generate a plurality of driving parameters for the electrical device 104. The control unit 102 transmits the generated driving parameters to a drive board or the electrical device 104. In an aspect, the control unit 102 generates an input signal corresponding to each of the plurality of driving parameters. The control unit 102 includes a housing that includes various other components such as drives, relays, switches, transformers, and such components to operate the electrical device 104. The control unit 102 can be used in low- and medium-voltage applications. In an aspect, the control unit 102 is configured to control a single electrical device, or a group of electrical devices that share similar functionality. The control unit 102 intends to determine whether the external power supply voltage matches a rated voltage of the electrical device 104.

The electrical device 104 is any basic discrete device or physical entity. The electrical device 104 may be classified as a passive electrical device, an active electrical device, or an electromechanics electrical device.

The drive board is an electronic circuit board that controls the functioning of the electrical device 104. The drive board receives the input signal from the control unit 102 and translates the received signals into commands that can drive the electrical device 104. The drive board is configured to protect the electrical device 104 from overload (rise of current over a long period) which can cause electrical failure and hamper the functionality. For example, for an electric motor, the drive board is configured to manage the speed, torque, direction, and resulting output of the motor and also regulates the automatic start and stop.

FIG. 2 is a schematic diagram of a system 200 for identifying an electrical device 220, according to aspects of the present disclosure. Each electrical device 220 includes a unique set of associated mechanical elements; therefore, the response of each electrical device (e.g., speed of a motor, angular position of a motor, or acceleration of a motor) is also unique. Each type of electrical device has different working principles, characteristics, and electrical parameters (referred to as identification information of an electrical device).

As shown in FIG. 2, the system 200 includes an identification unit 202, and a controller 204. The identification unit 202 is associated with the electrical device 220. The identification unit 202 is configured to generate an identification information representing at least one electrical parameter of the associated electrical device. In an example, the at least one electrical parameter includes maximum power, power deviation, average power, average active power, minimum power, energy consumption, average peak value, power dense location active power, reactive power, Vᵣₘₛ (root-mean-square value of voltage), Iᵣₘₛ (root mean square value of alternating current), and phase shift. For example, the identification unit 202 generates the identification information having a value of 1.05 corresponding to the Iᵣₘₛ of the associated electrical device. In one example, the identification unit 202 includes at least one resistor which is connected in series with a second resistor forming a voltage divider circuit. In an example, the identification information is a divided voltage from the voltage divider circuit. In another example, the identification unit 202 may be a defined voltage-providing unit that provides a unique defined voltage signal that defines the identification information of the electrical device 220. In another example, the identification unit 202 may be a defined frequency-providing unit that provides a unique defined frequency signal that defines the identification information of the electrical device 220.

In some embodiments, the identification unit 202 is placed within the electrical device 220. In some embodiments, the identification unit 202 is placed on an exterior surface of the electrical device 220. In an embodiment, the identification unit 202 is placed in proximity of the electrical device 220. The identification unit 202 is commutatively coupled to the electrical device 220.

In a structural aspect, as shown in FIG. 2, the electrical device 220 includes various components such as a communication unit 222, a wiring harness 226, and a circuit board connector 228. In an embodiment, the type of the electrical device 220 includes a motor, a battery, a heating device, a cooling device, a lighting device, a heating, ventilation, and air conditioning (HVAC) device, and a communication device. In an embodiment, the motor is at least one of a furnace induction motor, a furnace blower motor, an air handler blower motor, an alternating current (AC) motor, a synchronous motor, a reluctance motor, a direct current (DC) motor, and a compressor motor. The communication unit 222 is configured to receive the identification information from the identification unit 202. In examples, the communication unit 222 may receive the identification information from the identification unit 202 through wired and/or wireless means. The communication unit 222 of the electrical device 220 is configured to communicate the received identification information to the controller 204. In one example, the communication unit 222 includes a radio-frequency identification (RFID) tag 224 for communicating the identification information to the controller 204. In an example, the RFID tag 224 includes an antenna and a substrate. The antenna receives and transmits radio-frequency signals. The substrate holds the RFID tag 224 together. For example, the RFID tag 224 is passive, meaning that they have no power of its own and is activated by a reader's energy (in an example, the controller 204 acts as a reader). In another example, the communication unit 222 includes a Bluetooth unit for communicating the identification information to the controller 204. Other implementations of the communication unit 222 not disclosed here are contemplated herein.

The controller 204 is electrically coupled to the electrical device 220. The controller 204 is configured to receive the identification information from the identification unit 202. For example, and without limitation, the controller 204 may refer to a power signal controller, an operation control panel, a mobile device, Personal Digital Assistant (PDA), desktop computer, a cellular telephone, a tablet, a netbook, a wireless terminal, a laptop computer, or any other controlling device.

In an example, the controller 204 includes a processing unit and a memory. In some embodiments, the processing unit may be a circuit, and/or an integrated circuit. In some embodiments, the processing unit may be a computing device capable of executing predefined instructions. In certain implementations, the computing device may be a physical device or a virtual device. In many implementations, the processing unit may be any device capable of performing operations, such as a dedicated processor, a portion of a processor, a virtual processor, a portion of a virtual processor, a portion of a virtual device, or a virtual device. In some implementations, the processing unit may be a physical processor or a virtual processor. In some implementations, a virtual processor may correspond to one or more parts of one or more physical processors. In some implementations, instructions/logic may be distributed and executed across one or more processors, virtual or physical, to execute the instructions/logic.

Software and/or program instructions may be stored within the memory thereof to provide instructions to the processing unit for enabling an integral system thereof to perform various functions. For example, the memory may store software used by the integral system, such as an operating system, application programs, and associated databases. The controller 204 and its associated components may allow the integral system to run a series of computer-readable instructions to determine the operating parameters of the electrical device 220. In some implementations, the controller 204 may operate in a networked environment supporting connections to one or more remote clients, such as terminals, PC clients and/or mobile clients of mobile devices.

Herein, the memory may be volatile memory and/or non-volatile memory. The processing unit may execute instructions and/or code stored in the memory. A variety of computer-readable storage media may be stored in and accessed from the memory. The memory is configured to store the processed identification information, determined operating parameter of the electrical device 220. Also, the memory is configured to store a range of predefined values of the identification information associated with each type of electrical device, a range of predefined values of the operating parameters of the electrical device 220. The memory may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

The controller 204 is communicably coupled to the memory. For example, if the processed identification information represents a value of 4V, the controller 204 may determine that the connected electrical device is a DC motor. In examples, the controller 204 may determine the electrical device based on stored information or information hardwired in the circuits. In an example, the stored information may be a lookup table. In an example, hardwired information may be a circuit having data hardwired thereon.

The processing unit receives the identification information from the identification unit 202. The processing unit is configured to process the identification information and generate processed identification information. The controller 204 is configured to determine the device type of the electrical device based on based on processed identification information. In an aspect, the identification information of the electrical device 220 represents a type of electrical device 220. For example, the identification information has a value of 64.60 VAR corresponding to the reactive power of the electrical device 220. Based on the reactive power value, the controller 204 determines that the electrical device 220 is a fan. The controller 204 is configured to determine an operating parameter for the electrical device based, at least in part, on the device type. The controller 204 may, in some instances, control the electrical device and/or send data causing the electrical device to output certain actions. For example, the controller 204 may control operation of the electrical device based at least in part on the operating parameter. In another example, the controller 204 may cause the electrical device to implement a certain setting or perform a certain function.

Considering the motor as the electrical device 220, in an embodiment, the operating parameter of the motor includes an operating voltage, an operating phase, an operating current, an operating frequency, an armature voltage, a rotor speed, an output efficiency, an electrical time constant, a mechanical time constant, a revolutions per minute (RPM), an insulation class, a service factor (SF), and a torque-speed parameter.

The controller 204 fetches all the operating parameters associated with type of the electrical device 220. In another scenario, if the processed identification information represents a value of 7, that may belong to a heating device. In an aspect, the at least one type of the electrical device 220 includes a DC motor, an AC motor, a stepper motor, a brushless DC motor, a universal motor, a reluctance motor, a hysteresis motor, a servo motor, and like so.

The wiring harness 226 is electrically associated with and is coupled to the electrical device 220. In an aspect, the identification unit 202 is placed in the wiring harness.

The circuit board connector 228 is electrically coupled with the electrical device 220. In an embodiment, the identification unit 202 is placed in the circuit board connector 228.

In an embodiment, the system 200 includes an indication unit that signifies a plurality of attributes related to the electrical device 220. In an example, the plurality of attributes is selected from the group consisting of incompatibility of electrical device 220, electrical device damaged, overloading, excess current, likewise. In an aspect, the indication unit includes a plurality of LED lights. For example, a green LED indicates overloading, a red LED indicates a warning, and a yellow LED indicates excess current.

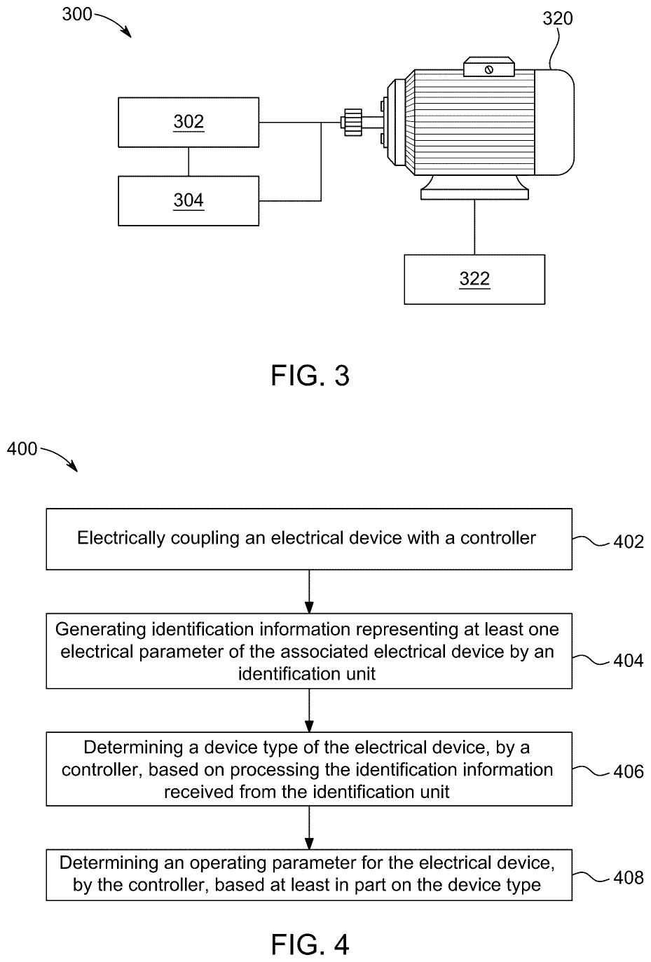

FIG. 3 is a schematic diagram of a system 300 for identifying a motor 320, according to aspects of the present disclosure. In an embodiment, the motor 320 is at least one of a furnace induction motor, a furnace blower motor, an air handler blower motor, an alternating current (AC) motor, a synchronous motor, a reluctance motor, a direct current (DC) motor, and a compressor motor. As shown in FIG. 3, the system 300 includes an identification unit 302, a communication device 322, and a motor controller 304.

The identification unit 302 is associated with the motor 320. The identification unit 302 is configured to generate identification information representing at least one electrical parameter of the associated motor. In an embodiment, the identification unit 302 includes at least one resistor which is connected in series with a second resistor forming a voltage divider circuit. In an example, the identification information is a divided voltage from the voltage divider circuit.

The communication device 322 is associated with the motor 320. The communication device 322 is configured to receive the identification information from the identification unit 302. In examples, the communication device 322 may receive the identification information from the identification unit 302 through wired and/or wireless means. The communication device 322 of the motor 320 (for example, electrical device) is configured to communicate the received identification information to the motor controller 304. In one example, the communication device 322 includes a radio-frequency identification (RFID) tag for communicating the identification information to the motor controller 304.

The motor controller 304 is electrically coupled to the motor 320. The motor controller 304 receives the identification information from the identification unit 302. The motor controller 304 is configured to process the identification information and generate a processed identification information. The motor controller 304 is configured to determine the type of the motor based on processing the identification information received from the identification unit 302. The motor controller 304 is configured to determine an operating parameter for the motor based, at least in part, on the device type. In an embodiment, the operating parameter of the motor 320 includes an operating voltage, an operating phase, an operating current, an operating frequency, an armature voltage, a rotor speed, an output efficiency, an electrical time constant, a mechanical time constant, revolutions per minute (RPM), an insulation class, a service factor (SF), and a torque-speed parameter.

In an aspect, the motor controller 304 includes a processing unit and a memory. In an example, the processing unit is a microprocessor which is configured to read a divided voltage received from the identification unit 302. For example, after receiving the information (divided voltage) the microprocessor generates a value of 3. The motor controller 304 fetches an electrical parameter saved corresponding to the value of 3. For example, value of 3 represents a torque having a value of 4.77 Nm. Further, other operating parameters such as power and speed can also be retrieved from the memory. For example, if torque is 4.77 Nm, speed is 1500 rpm and power is 0.75 KW. Based on the retrieved information, the motor controller 304 determines the type of the motor 320. According to an aspect of the present disclosure, the motor controller 304 may be implemented as one or more processors, microcontrollers, digital signal processors, logic circuitries, and/or any devices that manipulate signals based on operational instructions.

FIG. 4 illustrates a flowchart of a method 400 method of identifying an electrical device 220, according to an aspect of the present disclosure. The method 400 is described in conjunction with FIG. 2 through FIG. 3. At step 402, the method 400 includes electrically coupling an electrical device 220 with a controller 204. In an embodiment, the electrical device 220 is at least one of a motor, a battery, a heating device, a cooling device, a lighting device, a heating, ventilation, and air conditioning (HVAC) device, and a communication device. In an aspect, the motor is at least one of a furnace induction motor, a furnace blower motor, an air handler blower motor, an alternating current (AC) motor, a synchronous motor, a reluctance motor, a direct current (DC) motor, and a compressor motor.

At step 404, the method 400 includes generating identification information representing at least one electrical parameter of the associated electrical device 220 by an identification unit 202 associated with the electrical device 220. The identification unit 202 includes at least one resistor which is connected in series with a second resistor forming a voltage divider circuit. In an example, the identification information is a divided voltage from the voltage divider circuit. In an embodiment, the identification unit 202 is associated with the electrical device 220 by electrically coupling the identification unit 202 through at least one of placing the identification unit 202 on the electrical device 220, placing the identification unit 202 within the electrical device 220, placing the identification unit 202 on an exterior surface of the electrical device 220 and placing the identification unit 202 in a proximity of the electrical device 220.

At step 406, the method 400 includes determining a device type of the electrical device 220, by the controller 204, based on processing an identification information from the identification unit.

At step 408, the method 400 includes determining an operating parameter for the electrical device, by the controller, based at least in part on the device type. In an embodiment, the operating parameter of the motor comprises an operating voltage, an operating phase, an operating current, an operating frequency, an armature voltage, a rotor speed, an output efficiency, an electrical time constant, a mechanical time constant, revolutions per minute (RPM), an insulation class, a service factor (SF), and a torque-speed parameter. In some embodiments, the method 400 includes communicating the identification information, by a communication unit associated with the electrical device 220, to the controller 204.

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system for identifying an electrical device comprising:
an identification unit, associated with the electrical device, configured to generate an identification information representing at least one electrical parameter of the associated electrical device; and
a controller, electrically coupled to the electrical device, the controller configured to:
determine a device type of the electrical device based on processing the identification information from the identification unit; and
determine an operating parameter for the electrical device based, at least in part, on the device type.

2. The system of claim 1, wherein the electrical device is at least one of a motor, a battery, a heating device, a cooling device, a lighting device, a heating, ventilation, an air conditioning (HVAC) device, or a communication device; and
wherein the controller is further configured to:
controlling operation of the electrical device based at least in part on the operating parameter.

3. The system of claim 2, wherein the motor is at least one of a furnace induction motor, a furnace blower motor, an air handler blower motor, an alternating current (AC) motor, a synchronous motor, a reluctance motor, a direct current (DC) motor, or a compressor motor.

4. The system of claim 3, wherein the operating parameter of the motor comprises an operating voltage, an operating phase, an operating current, an operating frequency, an armature voltage, a rotor speed, an output efficiency, an electrical time constant, a mechanical time constant, revolutions per minute (RPM), an insulation class, a service factor (SF), or a torque-speed parameter.

5. The system of claim 1, wherein the identification unit comprises at least one resistor which is connected in series with a second resistor forming a voltage divider circuit, wherein the identification information is a divided voltage from the voltage divider circuit.

6. The system of claim 1, wherein the identification unit is associated with the electrical device by electrically coupling the identification unit through at least one of placing the identification unit on the electrical device, placing the identification unit within the electrical device, placing the identification unit with an exterior surface of the electrical device and placing the identification unit in a proximity of the electrical device.

7. The system of claim 1, further comprising a communication unit of electrical device configured to communicate the identification information to the controller.

8. The system of claim 1, further comprising a wiring harness electrically associated with and coupled to the electrical device, wherein the identification unit is placed in the wiring harness.

9. The system of claim 1, further comprising a circuit board connector electrically coupled with the electrical device, wherein the identification unit is placed in the circuit board connector.

10. The system of claim 1, wherein the electrical device further comprising a communications unit comprising a radio-frequency identification (RFID) tag for communicating the identification information to the controller.

11. A method of identifying an electrical device comprising:
electrically coupling an electrical device with a controller;
generating an identification information representing at least one electrical parameter of the associated electrical device by an identification unit associated with the electrical device;
determining a device type of the electrical device, by a controller, based on processing the identification information received from the identification unit; and
determining an operating parameter for the electrical device, by the controller, based, at least in part, on the device type.

12. The method of claim 11, wherein the electrical device is at least one of a motor, a battery, a heating device, a cooling device, a lighting device, a heating, ventilation, and air conditioning (HVAC) device, and a communication device.

13. The method of claim 12, wherein the motor is at least one of a furnace induction motor, a furnace blower motor, an air handler blower motor, an alternating current (AC) motor, a synchronous motor, a reluctance motor, a direct current (DC) motor, and a compressor motor.

14. The method of claim 13, wherein the operating parameter of the motor comprises an operating voltage, an operating phase, an operating current, an operating frequency, an armature voltage, a rotor speed, an output efficiency, an electrical time constant, a mechanical time constant, revolutions per minute (RPM), an insulation class, a service factor (SF), and a torque-speed parameter.

15. The method of claim 11, wherein the identification unit comprises at least one resistor which is connected in series with a second resistor forming a voltage divider circuit, wherein the identification information is a divided voltage from the voltage divider circuit.

16. The method of claim 11, wherein the identification unit is associated with the electrical device by electrically coupling the identification unit through at least one of placing the identification unit on the electrical device, placing the identification unit within the electrical device, placing the identification unit with an exterior surface of the electrical device and placing the identification unit in a proximity of the electrical device.

17. The method of claim 12, further comprising communicating the identification information, by a communication unit associated with the electrical device, to the controller.

18. A system for identifying electrical devices, the system comprising:
an identification unit associated with a first electrical device and a second electrical device, wherein the first electrical device is a first motor, and the second electrical device is a second motor, and wherein the identification unit is configured to generate (i) first identification information representing at least one electrical parameter of the first motor, and (ii) second identification information representing at least one electrical parameter of the second motor;
a first communication device associated with the first motor, the first communication device configured to communicate the first identification information from the first motor;
a second communication device associated with the second motor, the second communication device configured to communicate the second identification information from the second motor; and
a motor controller, electrically coupled to the first motor and the second motor, the motor controller configured to:
determine a first device type of the first motor based on processing the first identification information from the first identification unit;
determine a first operating parameter for the first motor based, at least in part, on the first device type;
determine a second device type of the second motor based on processing the second identification information from the second identification unit; and
determine a second operating parameter for the second motor based, at least in part, on the second device type.

19. The system of claim 18, wherein the first motor is at least one of a furnace induction motor, a furnace blower motor, an air handler blower motor, an alternating current (AC) motor, a synchronous motor, a reluctance motor, a direct current (DC) motor, or a compressor motor.

20. The system of claim 18, wherein the first operating parameter of the first motor comprises an operating voltage, an operating phase, an operating current, an operating frequency, an armature voltage, a rotor speed, an output efficiency, an electrical time constant, a mechanical time constant, revolutions per minute (RPM), an insulation class, a service factor (SF), or a torque-speed parameter.
